(19) United States
(12) Patent Application Publication
(10) Pub. No.: US 2007/0160036 A1
(43) Pub. Date: Jul. 12, 2007

(54) Method and system for servicing enhanced 911 calls

(76) Inventor: David M. Smith, Plano, TX (US)

Correspondence Address: MICHAEL L. DIAZ, P.C., 555 REPUBLIC DRIVE, SUITE 200, PIANO, TX, 75074, US

(21) Appl. No.: 11/328,411

(22) Filed: Jan. 10, 2006

(51) Int. Cl. H04L 12/66

(52) U.S. Cl. 370/356

(57) ABSTRACT

The present invention is a method and system for servicing enhanced 911 emergency calls. The present invention is utilized in a network providing Voice over Internet Protocol (VOIP) by a service provider to a user using a VoIP phone. When a user originates an emergency 911 call from the VoIP phone, a gateway communicating with a digital class 5 switch within the network, analyzes the signaling packets received from the VoIP phone and determines if a VoIP call originated by the user is an emergency 911 call. If the call is an emergency 911 call, the gateway will also determine if the VoIP call originates from the user's listed location provided to the service provider. If the call is not originated from the listed home location, the call is handled in a manner to prevent sending emergency response teams to the wrong location. The call may be processed and transferred to a specialized emergency call center which is informed that the call is not originating from the user's listed location. Alternatively, or in combination, a recording may be played informing the user and/or the call center that the call is not originating from the user's listed address.

### BACKGROUND OF THE INVENTION

1. Field of the Invention

This invention relates to telecommunications. Specifically, the present invention relates to a system and method for servicing enhanced 911 emergency calls.

2. Description of the Related Art

Voice over Internet Protocol (VOIP) provides a means for carrying telephone calls over packet networks that operate on the Internet Protocol (IP). The packet network may be a private network, such as a corporate LAN, or the public Internet. A telephone user may utilize a special IP-enabled telephone device, a normal telephone connected to a VoIP adapter (Analog Telephone Adapter or ATA), or a “softphone,” which is a computer program that is normally accessed through an inexpensive headset. These devices convert voice signals from a handset or headset to digital data that is transported by means of packets.

With these devices, telephone calls may be placed between users that are connected to the Internet. Telephone calls may also be placed between one user connected to the Internet (broadband) and another who uses a conventional telephone, if there is a service provided to transport the call from the Internet to the Public Switched Telephone Network (PSTN).

There are several attractive advantages of using VoIP, including the fact that a user's telephone number (or other form of identification) is related to the IP telephone device (softphone). In contrast, the telephone number for a conventional telephone line is associated with the physical line from the telephone company. If a VoIP user takes the IP device to a new location, such as a hotel with high-speed Internet access, the user's phone number follows the device.

Since most people still use conventional phones, while many people want to use VoIP, services are proliferating to provide the “gateway” between the Internet and the PSTN. The VoIP user often pays for this gateway service, and can use it from anywhere that Internet access is available, while retaining the same phone number.

It should be understood that the service provider is unable to determine the geographical location of the IP device from the Internet address. The IP device “registers” periodically with the service provider with its identification (phone number), pass code, and its current IP address. It is the nature of the Internet Protocol that IP devices send packets to a destination using only the IP address of the destination, while the network itself uses distributed routes to find the actual location of the destination.

Thus, with a conventional phone, the user's location is known because the phone number is associated with the phone company's physical line. With a VoIP phone connected to the Internet, the phone number is associated with the device, which could be located anywhere.

As a consequence, when the user of a conventional phone dials 911, the E911 (Enhanced 911) system provides information on the user's physical location to the 911 operator, by querying a database maintained for each phone line. When a VoIP user dials 911, the system can only provide the information that the user has put on file with the service provider. If the user has changed locations and neglected to update this information, the emergency operator will be given incorrect information. In the chaos of an emergency, if the caller neglects to give his location to the operator, the operator may in turn dispatch first responders to an empty house.

This is only a problem if the VoIP user is in a location different from what is on file with the service provider. Typically, the user supplies his home address to the service provider. If he calls from home, then the emergency operator receives the correct information from the E911 system. If the service provider could automatically detect when the VoIP caller was not calling from home, then special measures could be taken to prevent the erroneous dispatch of first responders. For example, the 911 call could be routed to a call center where operators would be trained to ask for physical location and routed to the correct emergency operator. As another example, a recorded announcement could be automatically played in the background of a 911 call to inform the 911 operator that the location information supplied by the E911 system may be incorrect, and to verify physical location with the caller. Currently, there are GPS devices being incorporated within mobile phones. However, there is no existing device or system which determines if the VoIP phone is located away from its home location by analyzing the Internet address of the VoIP phone. Therefore, a method and system of identifying when a VoIP caller is placing a 911 call from a location other than his home (or other registered address) by examining the VoIP phone's Internet address is needed. It is an object of the present invention to provide such a system and method.

### SUMMARY OF THE INVENTION

In one aspect, the present invention is an apparatus for servicing emergency calls utilizing Voice over Internet Protocol (VOIP) by a service provider to a user using a VoIP phone. The apparatus may be a gateway communicating with a digital class 5 switch. The apparatus determines if a VoIP call originated by the user is an emergency 911 call. Additionally, the apparatus determines if the VoIP call originates from the user's listed location provided to the service provider. If the VoIP call originates away from the listed location, the call may be processed to inform an emergency call center or the caller that the call is not originated from the listed location provided to the service provider.

In another aspect, the present invention is a telecommunications system utilizing Voice over Internet Protocol (VOIP) by a service provider to a user using a VoIP phone. The system includes a class 5 digital switch for processing calls and a gateway for processing and interpreting signaling packets sent between the VoIP phone and the gateway. The gateway determines if a VoIP call originated by the user is an emergency 911 call. The gateway also determines if the VoIP call originates from the user's listed location provided to the service provider. If the VoIP call originates away from the listed location, the call may be processed to inform an emergency call center or the caller that the call is not originated from the listed location provided to the service provider.

In still another aspect, the present invention is a method of servicing 911 emergency calls from a VoIP phone of a user. The method begins when a VoIP call is originated from a user's VoIP phone. A gateway then determines if the VoIP call is an emergency 911 VoIP call. The gateway also determines if the VoIP call is originating from a location listed as the home location of the user. Upon determining that the VoIP call is originating at a location different from the home location, the call is processed as an emergency 911 call originating away from the home location of the user.

### BRIEF DESCRIPTION OF THE DRAWINGS

FIG. 1 is a simplified block diagram illustrating the components of a telecommunications network utilizing a softphone in the preferred embodiment of the present invention;

FIG. 2 is a flow chart outlining the steps for servicing enhanced 911 emergency phone calls according to the teachings of the present invention; and

FIG. 3 is a flow chart outlining the steps for servicing enhanced 911 emergency phone calls in an alternate embodiment of the present invention.

### DESCRIPTION OF THE INVENTION

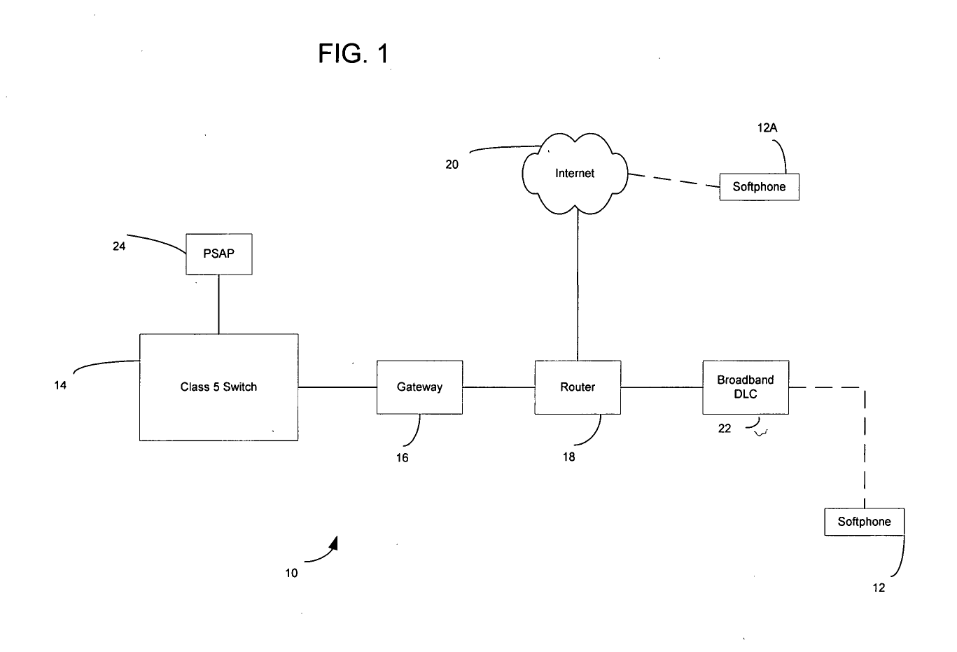

A system and method for servicing enhanced 911 calls is disclosed. FIG. 1 is a simplified block diagram illustrating the components of a telecommunications network 10 utilizing a softphone 12 in the preferred embodiment of the present invention. The telecommunications network includes a class 5 switch 14 connected to a gateway 16. The class 5 switch communicates via a standard signaling protocol, such as GR303, TRO8, ISDN PRI, SS7, etc. The signaling protocol provides a time division multiplexed (TDM) interface to the class 5 switch. The gateway 16 is connected to a router 18. The gateway may be a media gateway (MG) which converts TDM voice circuits and voice packets. Packets may be transported as 100baseT between the gateway 16 and the router 18. The router is connected to the Internet 20. Additionally, the router may be connected to a broadband DLC 22. Packets may also be transported as 100baseT between the router and the broadband DLC. The broadband DLC may provide DSL or fiber broadband connect to an IP phone, also known as a softphone 12. The class 5 switch normally communicates via a trunk with a Public Safety Answering Point (PSAP) 24 to provide 911 services to conventional phone callers serviced through the class 5 switch.

There is a trend to employ networks that carry both voice calls and data over common transport based on connectionless access protocols such as asynchronous transfer mode (“ATM”) and transport control protocol/internet protocol (“TCP/IP”). These networks are also referred to as “packet networks”. Packet networks simplify the problem of carrying both voice and data from region to region. Routing calls over such a network permits the use of common routing hardware controlled by so-called “soft switches”, which essentially are computers running call processing software.

“Media gateways,” such as the gateway 16, are specialized packet switches that also convert the time-division multiplexed digital format of voice calls on trunks from legacy class 5 switches 14 into the packetized formats used or vice versa in packet networks. Present methods require the use of a media gateway in order to route calls from legacy time-division multiplexed equipment through a packet network.

The present invention provides a device which enables conventional telephone service providers to service emergency phone calls originated by softphone by determining if the call originates from the user's home or another location. It should be understood that the user's home may be a business or other location which is on file with the service provider as the address for the softphone user.

In the present invention, the telephone service provider already handles conventional E911 calls from conventional phone lines. Thus, the telephone service provider operates the class 5 switch 14 with the necessary software and has one or more dedicated trunks to the PSAP 24. In the present invention, it is assumed that the service provider also operates a broadband access network, such as DSL or Fiber To The Premise (FTTP) to the user's “home.”

The present invention provides a bridge between the class 5 switch and the broadband access network. There are one or more packet interfaces, such as IP or asynchronous transfer mode (ATM) between the class 5 switch 14 and the gateway 16. The TDM voice circuits and voice packets are converted via the gateway 16 (e.g., media gateway) where the packets are received and interpreted. Additionally, dialing information to the TDM interface is generated. The gateway may also detect FSK signals from the TDM interface.

The gateway 16 and its associated components provide the bridge to enable VoIP service through the packet interfaces which may be connected to the carrier's broadband access network and the Internet. This may be accomplished with one packet interface and an external packet router connected to both the broadband access network and the Internet, or with two or more packet interfaces.

When a VoIP user originates a call through the softphone 12, the signaling packets are sent to the bridge (gateway 16). This bridge interprets the dialed number, opens a TDM connection to the class 5 switch and causes dialing information to be sent to the class 5 switch 14. The VoIP user hears the usual call progress tones sent back by the class 5 which, such as ringing and a busy signal. When the VoIP user is called, the class 5 switch signals the TDM interface, and the gateway 16 in turn sends corresponding signaling packets to the softphone 12. The gateway also sends corresponding signaling packets to the softphone 12. In most systems not using SS7 signaling protocols, If the class 5 switch 14 sends caller ID information, a FSK detector interprets the information and sends the called ID information to the softphone in a signaling packet. In either case, the gateway 16 converts audible information on the TDM interface to corresponding packet information on the packet interface, and vice versa.

However; it should be noted that the softphone 12 may be connected either to the broadband access network or to the public Internet (shown as a softphone 12A). If the bridge is connected to the access network and the Internet with a separate packet interface, then it can discriminate between calls that originate from each network by means of the interface from which the signaling information is received. Alternatively, if the gateway is connected to an IP switch, for example, with one packet interface, then it can discriminate between calls originating from the access network versus the Internet by means of the network and subnet information in the “from address” of the signaling packets received by the gateway 16.

If any call is originated from a softphone, the gateway is easily able to determine if it originates from the Internet. This allows the service provider to treat Internet origination as a separate billable service, e.g., a “vacation feature.” It also allows the service provider to route 911 calls originating from the Internet to a call center, by positioning the gateway with a different number to dial to the TDM interface. Alternatively, the gateway may be provisioned to place a recorded announcement to either the calling party, the emergency operator, or both parties.

If a VoIP call originates from the broadband access network, it is still possible that the user has moved the VoIP phone to another location served by the same DSL or FTTP network. This may be resolved by requiring the user to use a firewall at home. If the VoIP call originated from behind the same firewall, this may be determined by the gateway 16 by inspecting the signaling packets from the softphone 12. If it originated from behind a different firewall, or without a firewall, this may also be determined by the gateway to provide the appropriate routing of the call.

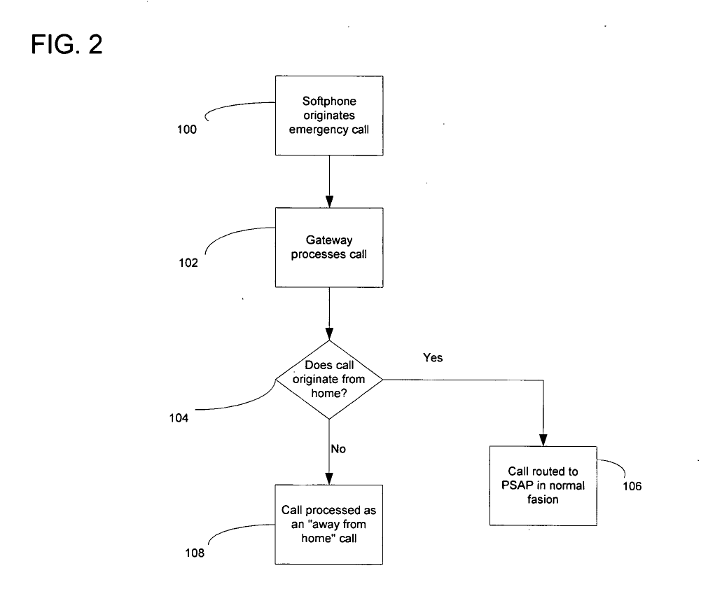

FIG. 2 is a flow chart outlining the steps for servicing enhanced 911 emergency phone calls according to the teachings of the present invention. With reference to FIGS. 1-2, the steps of the method will now be explained. In step 100, a caller originates an emergency 911 phone call from a softphone 12. It should be understood that the softphone may be any device which provides VoIP telephone calls over packet networks that operate on the Internet Protocol (IP). The call may originate from the user's home (i.e., where the user has a location on file with the service provider) or away from home (e.g., via the Internet or other location within the service provider's network). By originating a VoIP call, signaling packets are sent to the gateway 16. Next, in step 102, the gateway receives the signaling packets, interprets the dialed number, and opens a TDM connection to the class 5 switch 14.

Next, in step 104, the gateway 16 determines if the softphone call originates from the user's home or away from the home. The gateway may determine if the call originates from home versus the Internet by analyzing the “from address” of the signaling packets. If the gateway determines that the softphone call originates from the broadband access network, it is still possible that the user has moved the VoIP phone to another location served by the same DSL or FTTP network. Thus, the gateway may further determine what firewall address the call originates if the call originates from the proper broadband access network. As discussed above, the firewall at home may always be assigned the same IP address for a given firewall. Thus, if the VoIP call originates from behind the same firewall, the gateway may inspect the signaling packets and determined if the firewall has the same or different IP address.

If it is determine in step 104 that the call originates from the home of the user, the method moves from step 104 to step 106 where the 911 call is routed in the normal fashion to the PSAP 24. The gateway causes dialing information to be sent to the class 5 switch. In addition, the softphone user hears the usual call progress tones sent back from the class 5 switch (e.g., ringing or a busy signal).

However, if it is determined in step 104 that the call does not originate from the home of the user, the method moves from step 104 to step 108 where the 911 call is processed by the gateway 16 as an “away from home” call and processed in a different fashion than normal. The gateway causes dialing information to be sent to the class 5 switch. In addition, the softphone user hears the usual call progress tones sent back from the class 5 switch (e.g., ringing or a busy signal). The gateway may process the call to a different 911 call center where the operators are provided with information that the call does not originate from the user's known home address. Thus, the operators may query the softphone user of the current address of the user, transfer the call to the appropriate call center or send the appropriate emergency response to the appropriate location. In the alternative, the call may still be sent to the PSAP 24 but play a recorded announcement to either or both the calling party or the operator that the call is not originating from the user' home. Thus, the appropriate response and location may be sent by the 911 call center for VoIP calls. Additionally, the call is processed with the class 5 switch. The class 5 switch signals the TDM interface within the gateway. The gateway may also send corresponding signaling packets to the softphone. If the class 5 switch sends caller ID information, a FSK detector interprets the information and also sends other caller ID information to the VoIP device in a signaling packet. The gateway converts audible information on the TDM interface to corresponding packet information on the packet interface and vice versa.

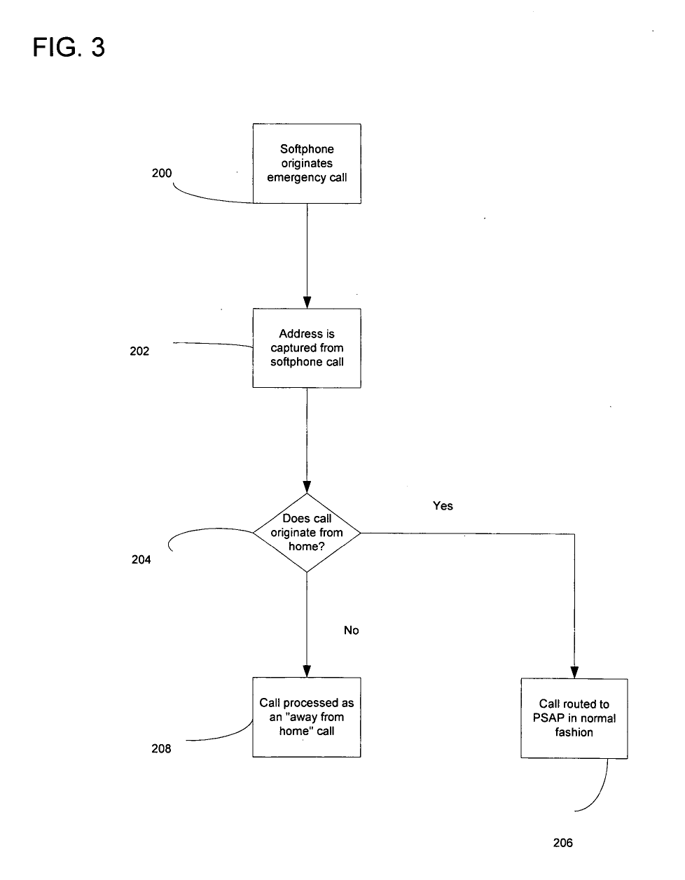

Rather than utilizing a bridge, such as the gateway 16, to analyze and determine if the VoIP phone is located at its registered home address, any device or system may be utilized to capture and analyze the “from address” of the softphone. FIG. 3 is a flow chart outlining the steps for servicing enhanced 911 emergency phone calls in an alternate embodiment of the present invention. With reference to FIGS. 1 and 3, the steps of the method will now be explained. In step 200, a caller originates an emergency 911 phone call from a softphone 12. The call may originate from the user's home (i.e., where the user has a location on file with the service provider) or away from home (e.g., via the Internet or other location within the service provider's network). By originating a VoIP call, signaling packets are sent through the Internet 20. Next, in step 202, an IP address or other “from” address is captured from the softphone.

Next, in step 204, it is determined if the softphone call originates from the user's home or away from the home. It may be determined if the call originates from home versus the Internet by analyzing the “from address” of the signaling packets. If the softphone call originates from the broadband access network, it is still possible that the user has moved the VoIP phone to another location served by the same DSL or FTTP network. Thus, the firewall address of the softphone may be further analyzed if the call originates from the proper broadband access network. As discussed above, the firewall at home may always be assigned the same IP address for a given firewall. Thus, if the VoIP call originates from behind the same firewall, the gateway may inspect the signaling packets and determined if the firewall has the same or a different IP address. If the softphone is using a different IP address, the softphone is not at the registered home.

If it is determine in step 204 that the call originates from the home of the user, the method moves from step 204 to step 206 where the 911 call is routed in the normal fashion to the PSAP 24.

However, if it is determined in step 204 that the call does not originate from the home of the user, the method moves from step 204 to step 208 where the 911 call is processed in a different fashion than normal. The call may be sent to a different 911 call center where the operators are provided with information that the call does not originate from the user's known home address. Thus, the operators may query the softphone user of the current address of the user, transfer the call to the appropriate call center or send the appropriate emergency response to the appropriate location. In the alternative, the call may still be sent to the PSAP 24, but also play a recorded announcement to either or both the calling party or the operator that the call is not originating from the user' home. Thus, the appropriate response and location may be sent by the 911 call center for VoIP calls.

The present invention provides many advantages over existing systems and methods. The present invention enables a VoIP user to originate an emergency phone call and automatically route the call to the appropriate call center or automatically provide a recording reminding either the 911 operator or the user that the call is not originated from the recorded home of the user. The present invention determines if a VoIP phone is located at its registered home location without the need for GPS by analyzing the Internet address of the VoIP phone.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An apparatus for servicing emergency calls utilizing Voice over Internet Protocol (VOIP) by a service provider to a user using a VoIP phone, the apparatus comprising:
means for determining if a VoIP call originated by the user is an emergency 911 call; and
means for determining if the VoIP call originates from the user's listed location provided to the service provider without utilizing a GPS device to determine the location of the VoIP phone.

2. The apparatus for servicing emergency calls of claim 1 wherein the means for determining if a VoIP call is an emergency call and the means for determining if the VoIP call originated from the user's listed location is incorporated within a gateway within the service provider's network.

3. The apparatus for servicing emergency calls of claim 2 wherein the gateway determines if the VoIP call originates within a network of the service provider.

4. The apparatus for servicing emergency calls of claim 3 wherein the gateway, upon determining that the call originates outside the network of the service provider, processes the VoIP call by informing an emergency call center that the VoIP call is originated away from the user's listed location.

5. The apparatus for servicing emergency calls of claim 4 wherein the gateway, upon determining that the call originates outside the network of the service provider, informs the emergency call center by providing a recording informing the emergency call center that the call is originated away from the listed location.

6. The apparatus for servicing emergency calls of claim 3 wherein the gateway, upon determining that the call originates outside the network of the service provider, transfers the emergency call to a specialized call center aware that the call is originated away from the listed location.

7. The apparatus for servicing emergency calls of claim 3 wherein the user uses a firewall at the listed location having a permanent address associated with the firewall and the gateway stores the permanent address of the firewall in a database;
the gateway, upon determining that the call originates within the network of the service provider, analyzes the address of the firewall and determines if the received address matches the stored permanent address of the firewall;
whereby the gateway determines that the call is originated away from the listed location of the user if the received address of the firewall does not match the stored permanent address of the firewall.

8. The apparatus for servicing emergency calls of claim 7 wherein the gateway, upon determining that the call originates within the network of the service provider and the address of the firewall does not match the stored address, processes the VoIP call by informing an emergency call center that the VoIP call is originated away from the user's listed location.

9. The apparatus for servicing emergency calls of claim 7 wherein the gateway, upon determining that the call originates within the network of the service provider and the address of the firewall does not match the stored address, informs the emergency call center by providing a recording informing the emergency call center that the caller is not at his listed location.

10. The apparatus for servicing emergency calls of claim 7 wherein the gateway, upon determining that the call originates within the network of the service provider and the address of the firewall does not match the stored address, transfers the emergency call to a specialized call center aware that the user is not at the listed location.

11. A telecommunications system utilizing Voice over Internet Protocol (VOIP) by a service provider to a user using a VoIP phone, the system comprising:
a class 5 digital switch for processing calls; and
a gateway for processing and interpreting signaling packets sent between the class 5 digital switch and the VoIP;
wherein the gateway determines if a VoIP call originated by the user is an emergency 911 call, the gateway determining if the VoIP call originates from the user's listed location provided to the service provider without utilizing a GPS device to determine the location of the VoIP phone.

12. The telecommunications system of claim 11 wherein the gateway determines if the VoIP call originates within a network of the service provider.

13. The telecommunications system of claim 11 wherein the gateway analyzes the network and subnet information within the signaling packets received from the VoIP phone to determine if the call originates within the network of the service provider.

14. The telecommunications system of claim 11 wherein the gateway, upon determining that the call originates outside the network of the service provider, processes the VoIP call by informing an emergency call center that the VoIP call is not originated from the user's listed location.

15. A method of servicing 911 emergency calls from a VoIP phone of a user, the method comprising the steps of:
originating a VoIP call from the VoIP phone of the user;
determining by a gateway communicating with a class 5 digital switch, if the VoIP call is an emergency 911 VoIP call;
determining by the gateway if the VoIP call is originating from a location listed as the home location of the user without utilizing a GPS device to determine the location of the VoIP phone; and
upon determining that the VoIP call is originating at a location different from the home location, processing the call as a emergency 911 call originating away from the home location of the user.

16. The method of servicing 911 emergency calls of claim 15 wherein the gateway, upon determining that the call originates outside the network of the service provider, processes the VoIP call by informing an emergency call center that the VoIP call is not originated from the user's listed location.

17. The method of servicing emergency calls of claim 15 wherein the gateway, upon determining that the call originates outside the network of the service provider, transfers the emergency call to a specialized call center aware that the user is not at the listed location.

18. The method of servicing emergency calls of claim 15 wherein the user uses a firewall at the listed location having a permanent address associated with the firewall and the gateway stores the permanent address of the firewall in a database;
the gateway, upon determining that the call originates within the network of the service provider, analyzes the address of the firewall and determines if the received address matches the stored permanent address of the firewall;
whereby the gateway determines that the call is not originated at the listed location of the user if the received address of the firewall does not match the stored permanent address of the firewall.

19. The method of servicing 911 emergency calls of claim 18 wherein the gateway, upon determining that the call originates within the network of the service provider and the address of the firewall does not match the stored address, processes the VoIP call by informing an emergency call center that the VoIP call is not originated from the user's listed location.

20. The method of servicing 911 emergency calls of claim 19 wherein the gateway, upon determining that the call originates within the network of the service provider and the address of the firewall does not match the stored address, informs the emergency call center by providing a recording informing the emergency call center that the caller is not at his listed location.

21. A method of servicing 911 emergency calls from a VoIP phone of a user, the method comprising the steps of:
capturing an address from the VoIP phone of the user originating a VoIP call;
determining if the VoIP call is an emergency 911 VoIP call;
determining from the address of the VoIP phone if the call is originating from a location listed as the home location of the user without utilizing a GPS device to determine the location of the VoIP phone; and
upon determining that the VoIP call is originating at a location different from the home location, processing the call as a emergency 911 call originating away from the home location of the user.

22. The method of servicing 911 emergency calls of claim 21 wherein the step of determining if the VoIP call originates from a location listed as the listed location of the user includes analyzing the network and subnet information within signals sent from the VoIP phone to determine if the call originates within a network of a service provider providing service to the VoIP phone at the user's listed location.

23. The method of servicing 911 emergency calls of claim 22 further comprises the step of, upon determining that the call originates outside the network of the service provider, the step of processing the VoIP call by informing an emergency call center that the VoIP call is not originated from the user's listed location.

24. The method of servicing emergency calls of claim 22 further comprising the step of, upon determining that the call originates outside the network of the service provider, transferring the emergency call to a specialized call center aware that the user is not at the home location.
